(19) United States
(12) Patent Application Publication
(10) Pub. No.: US 2019/0277793 A1
(43) Pub. Date: Sep. 12, 2019

(54) LOW TEMPERATURE ELECTROCHEMICAL REFERENCE ELECTRODE AND SYSTEMS USING THE SAME

(71) Applicant: METOXS PTE. LTD., Singapore (SG)

(72) Inventors: Hassan Elsentriecy, Tucson, AZ (US); Abraham Fouad Jalbout, Tucson, AZ (US)

(21) Appl. No.: 16/463,791

(22) PCT Filed: Mar. 24, 2017
(86) PCT No.: PCT/IB2017/051669

§ 371 Date: May 23, 2019

Related U.S. Application Data
(60) Provisional application No. 62/425,881, filed on Nov. 23, 2016.

(51) Int. Cl. G01N 27/30; G01N 17/02

(52) U.S. Cl. CPC G01N 27/301; G01N 17/02

(57) ABSTRACT

Reference electrodes include a hollow cylindrical body having a proximal end and a distal end; an electrically conductive metal wire partially coated with a metal salt, the wire extending through the proximal end of the cylindrical body and terminating near the distal end of the cylindrical body; an ionic liquid contained within a portion of the cylindrical body, the coated portion of the wire being submerged in the ionic liquid; an air-tight seal on the proximal end of the cylindrical body, the uncoated portion of the wire extending through the air-tight seal; and a ceramic rod discontinuously fused with an inner surface of the cylindrical body at a portion of the distal end. An electrochemical sensor for measuring the corrosion rate of a metal or alloy, at temperatures of about −100° C. to about 200° C., has an electrochemical cell in a test loop and includes an ionic liquid-containing reference electrode.

### CROSS-REFERENCE TO RELATED APPLICATIONS

This application claims the benefit of U.S. provisional application No. 62/425,881, filed Nov. 23, 2016, the contents of which is incorporated by reference herein in its entirety.

### FIELD OF THE INVENTION

The present invention relates to electrochemical reference electrodes for use in extremely cold conditions, such as about −100° C. to 0° C., to perform electrochemical measurements for both corrosion monitoring and/or corrosion rates determinations for any metal or metal alloy under such conditions. The present invention further relates to methods of making electrochemical reference electrodes for use in such conditions.

### BACKGROUND OF THE INVENTION

Metal pipes used in various industrial applications can be susceptible to deterioration over time, such as due to corrosion when pipes are carrying electrolyte fluids. This requires that pipes be monitored to assess the rates of deterioration and to attend to scheduled maintenance for replacement of damaged pipes. The conventional gravimetric measurement for determining metal corrosion rates, which is set forth in ASTM Standard D2688, can take weeks, months, or even years to yield an average corrosion rate. An average weight loss over time is acceptable when corrosion rates are steady, but if electrolyte flow and chemistry are changing over time, it is preferred to have a quick non-destructive method for repeatedly monitoring the changing corrosion rate and the changing conditions themselves.

One non-destructive method of measuring metal corrosion rates is an electrochemical method, which typically takes only a few minutes, so the effects of variations in chemistry, temperature, or flow of the material inside the pipe can be resolved virtually in real time. An electrochemical corrosion rate determination set forth in the Stern-Geary method, such as described in Ming-Kai Hsieh et al., “Bridging Gravimetric and Electrochemical Approaches to Determine the Corrosion Rate of Metals and Metal Alloys in Cooling Systems: Bench Scale,” Ind. Eng. Chm. Res. 2010, 49, 9117-9123 and incorporated herein by reference, takes minutes to perform and is non-destructive and therefore useful for monitoring the state of health of the pipe metal. This method allows one to assess when to do system component repairs or replacements ahead of failure. However, this method is limited because it cannot be used to detect corrosion or determine corrosion rates in extremely cold temperature environments. Thus, these methods have been unable to be used in connection with measuring corrosion and corrosion rates in, for example, oil pipelines passing through extremely cold areas.

In general, reference electrodes are made of a hollow cylindrical glass body a metallic wire for electrical connection, such as silver wire in Ag/AgCl and platinum wire in Hg/Hg₂Cl₂ reference electrodes, extending longitudinally through at least a portion of the glass body and an electrolyte buffer solution such as a saturated KCl solution. Current reference electrodes cannot be used under extremely cold conditions, such as −20° C. or below, because the electrolyte solution inside the electrode may freeze which will result in breaking the glass body of the electrode. Additionally, when used in such extremely cold temperatures, obtaining electrochemical potential measurements is likely to be unsuccessful because such temperatures impede ionic conductivity of electrolyte solutions and, furthermore, between the inside of the reference electrode and the environment surrounding the reference electrode.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a photograph of a reference electrode, in accordance with various aspects of the present disclosure;

FIG. 2 is an illustration of a system for the determination of the Instantaneous Corrosion Rate (ICR) of a metal or alloy in an electrolyte environment in accordance with various aspects of the present disclosure;

FIG. 3 is a photograph of an Agar-KCl paste/ionic liquid mixture salt bridge in accordance with various aspects of the present disclosure;

FIG. 4 is a photograph of an experimental setup for measuring the open circuit potential (OCP) of a reference electrode having an ionic liquid electrolyte, in accordance with various embodiments of the present disclosure;

FIG. 5 is a graph showing the OCP of an Ag/AgCl/HMIC reference electrode versus a standard Ag/AgCl reference electrode over time at room temperature, in accordance with various aspects of the present disclosure;

FIG. 6 is a graph showing the OCP of an Ag/AgCl/HMIC reference electrode versus a standard Ag/AgCl reference electrode over time at −75° C., in accordance with various aspects of the present disclosure; and

FIG. 7 is a combination of the data provided in FIGS. 5 and 6.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, and alternatively ±1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

For the purposes of this specification and appended claims, the term “coupled” refers to the linking or connection of two objects. The coupling can be permanent or reversible. The coupling can be direct or indirect. An indirect coupling includes connecting two objects through one or more intermediary objects. The term “substantially” refers to an element essentially conforming to the particular dimension, shape or other word that substantially modifies, such that the component need not be exact. For example, substantially circular means that the object resembles a circle, but can have one or more deviations from a true circle.

The present disclosure is directed to the fabrication of ionic liquid-containing reference electrodes which are operable temperatures as low as, for example, −100° C. The present disclosure is further directed to methods of electrochemically detecting corrosion or of measuring corrosion rates of metals or alloys at temperatures as low as, for example, −100° C. using ionic liquid-containing reference electrodes.

Ionic liquids (ILs) are salts that melt at relatively low temperatures. Some ionic liquids are known to have melting points below room temperature (˜25° C.) and are appropriately referred to as room-temperature ionic liquids (RTILs). ILs are generally composed of organic cations and anions such as, for example, halides (i.e., Cl⁻, Br⁻, and I⁻), tetrafluoroborate (BF₄⁻), hexafluorophosphate (PF₆⁻), bis(trifluoromethylsulfonyl)imide (Tf₂N⁻), nonaflate (CF₃CF₂CF₂CF₂SO₃⁻), triflate (TfO⁻), tetrachloroaluminate (AlCL₄⁻), acetate (CH₃CO₂⁻), trifluoroacetate (CF₃CO₂⁻), nitrate (NO₃⁻), nitrite (NO₂⁻), trifluoromethanesulfonate (CF₃SO₃⁻), and so on. ILs generally show a good ionic conductivities over broad temperature ranges. Ionic liquids are also general liquid in form over a broad temperature range. Furthermore, ionic liquids are known to exhibit a wide range of solubilities, viscosities and densities which may easily be altered by the use of specific cations and anions and/or augmenting their hydrophilicity/hydrophobicity. Most ILs also exhibit extremely low vapor pressures which produce minimal amounts of volatile organic compounds, meaning they are nonvolatile, nonflammable and have good thermal stability. Such properties make ILs a promising green chemical alternative to other solvents or solutions commonly used in the art.

The present disclosure provides methods of electrochemically detecting metal or alloy corrosion. In some instances, methods according to various aspects of the present disclosure can include electrically coupling an ionic liquid-containing reference electrode to an electrometer, submerging the reference electrode and a sample metal or alloy in a mixture comprising one or more low temperature melting point electrolytes at a temperature of about −100° C. to about 200° C., alternatively −100° C. to about 0° C., and alternatively −75° C. to about −20° C., and measuring the voltage of the reference electrode and comparing it to a predetermined voltage threshold to determine if corrosion of the sample metal or alloy has occurred.

In some instances, ionic liquid-containing reference electrodes according to various aspects of the present disclosure can include a hollow cylindrical enclosure having a proximal end and a distal end, a low-melting point ionic liquid contained with the cylindrical enclosure, and an electrically conductive wire extending through the proximal end of the cylindrical enclosure and having a portion thereof submerged in the low-melting point ionic liquid. The electrically conductive wire extends through a seal on the proximal end of the cylindrical enclosure. The seal prevents exposure of the inner portion of the reference electrode to external conditions. The distal end has an opening for ionic conduction between the reference electrode and a working electrode. Specifically, the distal end has a rod fused or sealing connected to the opening of the distal end and forming a microcracks-containing liquid junction therebetween.

The cylindrical enclosure is both thermally and chemically inert, and can be made of, for example, a glass such as a soda-lime glass, a borosilicate glass, a chalcogenide glass, a lead-oxide glass, or fused quartz. The rod can be made of any one of zirconia, alumina, or any ceramic having ion conducting properties sufficient for use in electrodes.

The ionic liquid can have a melting point between about −100° C. and about 200° C., alternatively between about −100° C. and about 0° C., and alternatively between about −100° C. and about −20° C. In some instances, a mixture of one or more ionic liquids can be used in the reference electrode. The use of such low temperature melting point ionic liquids render the reference electrodes disclosed herein especially useful for electrochemical measurements in extremely cold environments. Additionally due to the broad range of temperatures in which ionic liquids are liquid in form, reference electrodes according to the present disclosure can find utility in electrochemical measurements in environments having temperatures which may vary from −100° C. to about 200° C.

The electrically conductive wire can be any electrically conductive wire known to one of ordinary skill in the art suitable for use with low melting point ionic liquids. In some instances, the electrically conductive wire can be a silver wire in an Ag/AgCl electrode. In other instances the electrically conductive wire can be another chloride-based electrode such as Cu/CuCl electrode, an Hg/Hg₂Cl₂ electrode, a Ni/NiCl₂ electrode, an Fe/FeCl₂ or an Fe/FeCl₃ electrode, a Sn/SnCl₂ electrode, a Pb/PbCl₂ electrode, or a Mn/MnCl₂ electrode. When a chloride-based electrode is used, an ionic liquid having a chloride ion should be used. In some instances, the ionic liquid can be, for example, trihexyl(tetradecyl)phosphonium chloride (THTDPC, M.P.=−50 to −70° C., viscosity=2,729 mPa·s at 25° C.), 1-hexyl-3-methylimidazolium chloride (HMIC, M.P.=−75 to −85° C., viscosity=7826 mPa·s at 20° Q, and 1-benzyl-2-ethylimidazolium chloride (BEIC, M.P. =−86° C.). One of ordinary skill in the art may readily appreciate, however, that the synthesis of ionic liquids is a constantly growing field and generally any ionic liquid, which has a chloride ion, with a low melting point (i.e. about −100 to 0° C.) and a suitable viscosity can be used within the scope of the present disclosure. In some instances, a sulfate-based electrically conductive wire can be used such as, for example, Cu/CuSO₄, Hg/Hg₂SO₄, or Ag/Ag₂SO₄. When a sulfate-based electrically conductive wire is used, an ionic liquid having a hydrogen sulfate ion (HSO₄⁻) or an alkyl or aryl sulfate ion should be used.

The present disclosure further provides a method electrically coupling a reference electrode according to various aspects of the present disclosure to an electrometer, electrically coupling a working electrode formed from a sample metal or alloy to the electrometer, electrically coupling a counter electrode to the working electrode, submerging the reference electrode, the working electrode, and the counter electrode in a liquid electrolyte at a temperature as low as −100° C., and generating a current by scanning a working electrode potential to generate a polarization curve from which a corrosion rate can be calculated.

Corrosion rate is linearly related to corrosion current, which is the current for the metal oxidation reaction at the corrosion potential and is derived from a polarization curve when zero current flows between the working electrode and the counter or reference electrode. Measuring the voltage between the working and reference electrode when zero current flows between the working and counter or references electrodes determines the corrosion potential, E^{corr}, versus the reference electrode potential. Differing values of E^{corr} may be indicative of varying degrees of corrosion in a metal or alloy environment such as piping, a storage tank or any other structure made of a metal or alloy requiring low temperature corrosion evaluation.

The present disclosure further provides an electrochemical sensor for measuring the corrosion rate of a metal or alloy which includes an electrochemical cell in a test loop having a reference electrode, according to various aspects of the present disclosure, electrically coupled with an electrometer, a working electrode formed of a sample metal or alloy electrically coupled with the electrometer, a counter electrode electrically coupled with the working electrode, and a potentiostat electrically coupled with the electrometer, wherein the corrosion rate of the sample metal or alloy is measured in the presence of a stagnant or flowing electrolyte-containing solution.

As outlined above, the present disclosure is directed to reference electrodes for, and electrochemical methods of, detecting (that is, monitoring and/or measuring) corrosion of metals in the presence of an electrolyte solution at temperatures of about −100° C. to about 200° C., alternatively −100° C. to about 0° C., and alternatively −75° C. to about −20° C. The electrolyte solution can be made of any ionically conductive aqueous or non-aqueous electrolyte or a mixture of aqueous or non-aqueous electrolytes. The electrolyte solution can be made of one or more ionic liquids or molten salt that have melting points between about −100° C. and about 200° C. A corrosion mechanism of a local cell follows the following general mechanism. The local cell is made of a metal or alloy having a local anode and a local cathode. A portion of the metal or alloy, in the presence of for example water and dissolved oxygen either in aqueous solutions or present as contaminants in non-aqueous solutions (such as ionic liquids or molten salts), oxidizes at the local anode on the metal or alloy surface, according to equation 1:

M→Mⁿ⁺+ne⁻ (1)

wherein M is a metal such as chromium, copper, nickel, iron, or any other suitable metal or metal contained within an alloy.

The metal ion enters the corrosion medium, which can be either aqueous or non-aqueous, while the electrons travel from the local anode to a local cathode via the corrosion medium and carry positive current. The electrons then reduce oxygen in the presence of water which is in contact with the local cathode. The oxygen reduction at the local cathode can take place as follows:

O₂+4H⁺+4e⁻→2H₂O (in acidic conditions) (2)

or

O₂+2H₂O+4e⁻→4OH⁻ (in basic conditions) (3)

In a neutral environment (i.e., pH=7), both equations 2 and 3 occur.

When electrons flow in the metal or alloy, ions must flow into the surrounding liquid, here an electrolyte solution, to balance the electrical charge. The flow of ions completes the current loop. Charge balance reactions in an ionic liquid, when an ionic liquid is used as the electrolyte solution, made of an organic cation and a chloride anion (R—Cl) are shown in equation 6:

Mⁿ⁺+nRCl→Mⁿ⁺Cl⁻ₙ+nR⁺ and 2nR⁺+nO²⁻→nR⁺₂O²⁻ (6)

According to this local cell corrosion mechanism, if only equation 1 occurs, no corrosion should be present, because structural materials would be held together by the electrostatic interaction between positive metal ions on the surface of the metal or alloy and negative electron charge inside of the metal or alloy. However, since the electrons are removed by the oxidants (e.g., oxygen or water), the metal or alloy is no longer negatively charged, and instead becomes neutral in charge, so positive metal ions leave the metal and metal weight loss (i.e., corrosion) occurs.

According to the methods discussed herein, the Instantaneous Corrosion Rate (ICR) for a sample metal or alloy can be accurately estimated either with a stagnant electrolyte solution (batch) or a flowing electrolyte solution. By monitoring the voltage between a metal or alloy and a reference electrode and the current and voltage properties of the metal or alloy, and by monitoring properties of the electrolyte solution, such as conductivity, dissolved oxygen concentration, dissolved water concentration, pressure, and flow rate of the electrolyte solution, a field test site with a real-time in line instrument for warning of corrosive environments and monitoring ICR can be created.

To prevent metal or alloy pipe breaks, the deterioration storage tank metal or alloy walls, or the deterioration of metal or alloy components in various systems, due to corrosion of the corresponding metal or alloy, the invention provides a corrosion detection method and system which warns of the presence and effects of dissolved oxidants in an electrolyte solution and can operate at the temperatures above the melting point of the electrolyte, which, depending on the electrolyte, may be range from about −100° C. to about 200° C. The electrolyte can have a melting point ranging from about −100° C. to about 200° C. The electrolyte solution can be made of any ionically conductive aqueous or non-aqueous electrolyte or a mixture of aqueous or non-aqueous electrolytes. In some instances, the electrolyte solution can be made of one or more ionic liquids or molten salts that have melting points between about −100° C. and about 200° C. In other instances, the electrolyte solution can comprise a mixture comprising one or more low temperature melting point ionic liquids, wherein at least one of the one or more of the ionic liquids has a chloride ion. As discussed above, methods of electrochemically detecting corrosion or of calculating the corrosion rate of a metal or alloy are provided herein. The methods disclosed herein are advantageous because they can be utilized in environments at temperatures of about −100° C. to about 200° C., alternatively −100° C. to about 0° C., and alternatively −75° C. to about −20° C. Detecting corrosion already present in metal structures such as pipes or storage tanks is important to understand the “state of health” of a system, so as to avoid any potential deterioration of the structure. This method may also be used to determine corrosion rates of metal or alloy structures, or components, to monitor the state of health of a system in extremely cold environments.

Methods according to the present disclosure utilize an ionic liquid-containing reference electrode, which is in an ionic conducting solution, called a half-cell, with a constant electrode potential. Ionic liquid-containing reference electrodes according to various aspects of the present disclosure can be used to measure the potential of a metal or alloy sample in an electrolyte solution having a melting point ranging from about −100° C. to about 200° C. The electrolyte solution can be made of any ionically conductive aqueous or non-aqueous electrolyte or a mixture of aqueous or non-aqueous electrolytes. In some instances, the electrolyte solution can be made of one or more ionic liquids or molten salts that have melting points between about −100° C. and about 200° C. In other instances, the electrolyte solution can comprise a mixture comprising one or more low temperature melting point ionic liquids, wherein at least one of the one or more of the ionic liquids has a chloride ion. A metal or alloy in contact with a corresponding electrolyte has constant potential and is the basis for making ionic liquid-containing reference electrodes in accordance with various aspects of the present disclosure. Ionic liquid-containing reference electrodes used in such environments were developed to simulate the traditional silver/silver chloride (Ag/AgCl) reference electrode (SSE) used in aqueous electrolyte solutions.

In some instances, a stable and robust ionic liquid-containing reference electrode may be made from a metal wire (like silver wire, Ag-wire) which is at partially coated with a corresponding ionic metal salt (i.e., silver chloride, AgCl). The coated portion of the metal wire and an ionic liquid is placed inside a glass tube with an insulating ceramic rod (like alumina or zirconia rod) sealed at the bottom, such as by melting it into one end of the glass tube. Due to differences in thermal expansion coefficients of the ceramic rod and the glass, microcracks form at the glass and ceramic rod interface (commonly referred to as a cracked junction, CJ) resulting in a complex, non-linear, path for ion conduction (or ion diffusion or ion exchange) from inside the glass tube to outside the tube to provide ionic contact to the electrochemical cell. Ion exchange is needed in order to complete the electrical connection between the reference electrode and the working electrode under test in the electrolyte, so the potential of the working electrode under test can be measured and controlled during the electrochemical polarization measurements of the working electrode.

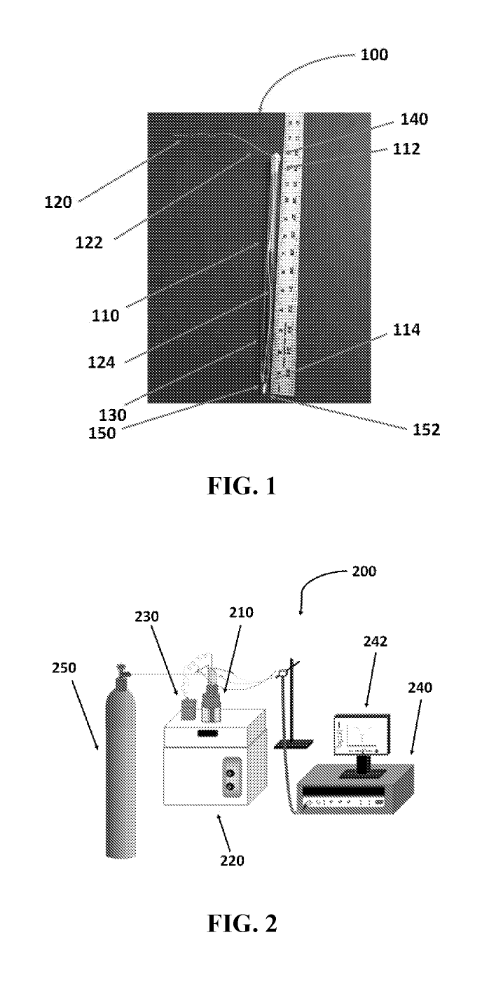

FIG. 1 is a photograph of a reference electrode, in accordance with various aspects of the present disclosure. The reference electrode 400 includes a hollow cylindrical body 110 having a proximal end 112 and a distal end 114, an electrically conductive metal wire 120 extending through the proximal end 112 and terminating near the distal end 114, and an ionic liquid 130 contained with a portion of the hollow cylindrical body 110. The electrically conductive metal wire 120 includes a first portion 122 which is uncoated and a second portion 124 which is coated with a salt having a metal cation which is the same as the metal of the wire 120. The second portion is submerged in the ionic liquid 130. The hollow cylindrical body 110 is isolated from the external environment at the proximal end 112 with an air-tight seal 140. A ceramic rod 150 is discontinuously fused with an inner surface of hollow cylindrical body 110 at a portion of the distal end 114 to form a cracked junction 152. As discussed above, due to differences in thermal expansion coefficients of the ceramic rod 150 and the hollow cylindrical body 110, microcracks form at the interface of the hollow cylindrical body 110 and the ceramic rod 150 resulting in a complex, non-linear, path for ion conduction hollow cylindrical body 110 tube to provide ionic contact to an electrochemical cell.

The cylindrical body 110 is both thermally and chemically inert. The cylindrical body 110 can be made of, for example, a glass such as a soda-lime glass, a borosilicate glass, a chalcogenide glass, a lead-oxide glass, or fused quartz.

The ceramic rod 150 rod can be made of any one of zirconia, alumina, or any other ceramic suitable for ion conduction as know by one of ordinary skill in the art.

The electrically conductive metal wire 120 can be any electrically conductive wire known to one of ordinary skill in the art suitable for use with low melting point ionic liquids. In some instances, the electrically conductive wire can be an Ag/AgCl electrode. In other instances the electrically conductive wire can be another chloride-based electrode such as Cu/CuCl electrode, a Hg/Hg₂Cl₂ electrode, a Ni/NiCl₂ electrode, an Fe/FeCl₂ or an Fe/FeCl₃ electrode, a Sn/SnCl₂ electrode, a Pb/PbCl₂ electrode, or a Mn/MnCl₂ electrode. When a chloride-based electrode is used an ionic liquid having a chloride ion should be used. In some instances, a sulfate-based electrically conductive wire can be used such as, for example, Cu/CuSO₄, Hg/Hg₂SO₄, or Ag/Ag₂SO₄. When a sulfate-based electrically conductive wire is used, and ionic liquid having a hydrogen sulfate ion (HSO₄⁻) or an alkyl or aryl sulfate ion should be used.

The ionic liquid 130 is composed of one or more ionic liquids which exhibit melting points of about −100° C. to about 200° C., alternatively −100° C. to about 0° C., and alternatively −75° C. to about −20° C. In some instances, the ionic liquid 130 can be, for example, trihexyl(tetradecyl)phosphonium chloride (THTDPC, M.P. =−50 to −70° C., viscosity=2,729 mPa·s at 25° C.), 1-hexyl-3-methylimidazolium chloride (HMIC, M.P. =−75 to −85° C., viscosity=3,400,000 mPa·s at 40° C.), and 1-benzyl-2-ethylimidazolium chloride (BEIC, M.P. =−86° C.). One of ordinary skill in the art may readily appreciate, however, that the synthesis of ionic liquids is a constantly growing field and generally any ionic liquid, which has a chloride ion, with a low melting point (i.e. about −100 to 0° C.) and a suitable viscosity can be used within the scope of the present disclosure.

In methods according to various aspects of the present disclosure, a reference electrode is connected to an electrometer (e.g., a voltmeter) in an environment inside of the structure (i.e., pipe or storage tank) to be tested. The environment contains an electrolyte solution having a melting point ranging from about −100° C. to about 200° C. The electrolyte solution can be made of any ionically conductive aqueous or non-aqueous electrolyte or a mixture of aqueous or non-aqueous electrolytes. In some instances, the electrolyte solution can be made of one or more ionic liquids or molten salts that have melting points between about −100° C. and about 200° C. In other instances, the electrolyte solution can comprise a mixture comprising one or more low temperature melting point ionic liquids, wherein at least one of the one or more of the ionic liquids has a chloride ion. The negative lead of the voltmeter is connected to the reference electrode, while the positive lead of the voltmeter is connected to a piece of sample metal or alloy. The sample metal or alloy should be the same metal or alloy from which the structure of interest (for example, pipe, storage tank, or metal or alloy component) is formed. The entire cell is then placed in the electrolyte inside of the structure of interest. The voltage of the sample metal versus the reference electrode in this environment is then measured. If the voltage is at or above a predefined threshold based upon the type of metal or alloy in a mixture of one or more ionic liquids with air, it can be determined that air has leaked into the mixture of one or more ionic liquids located inside of the structure, due to corrosion. If the voltage is below the predefined threshold, based upon the type of metal or alloy in the electrolyte solution, it can be determined that the state of health of the system is acceptable and no corrosion is present.

FIG. 2 is an illustration of a system for the determination of the Instantaneous Corrosion Rate (ICR) of a metal or alloy in an electrolyte solution environment. The electrolyte solution can be made of any ionically conductive aqueous or non-aqueous electrolyte or a mixture of aqueous or non-aqueous electrolytes. In some instances, the electrolyte solution can be made of one or more ionic liquids or molten salts that have melting points between about −100° C. and about 200° C. In other instances, the electrolyte solution can comprise a mixture comprising one or more low temperature melting point ionic liquids, wherein at least one of the one or more of the ionic liquids has a chloride ion. In FIG. 2, the system 200 includes a three-electrode cell 210, a cooling unit 220, an electrometer 230 (e.g., voltmeter), and a potentiostat 240 (e.g., a computerized controller with data logging capabilities). The potentiostat 240 can be electronically coupled to a user interface 242. The three-electrode cell 210 includes three (3) electrodes: (1) the metal or alloy to be tested, or the working electrode (WE), (2) a reference electrode (RE), such as those described herein to measure the potential of the WE, and (3) a counter electrode (CE) to pass current from the WE, wherein the counter electrode is formed of the same metal or alloy as the working electrode. The three-electrode cell 210 is placed in an electrolyte (as previously described), which is maintained at a temperature of about −100° C. to about room temperature in the cooling unit 220. The WE and RE are electrically coupled with the electrometer 230 which is electrically coupled with the potentiostat 240. A gas cylinder 250 (preferably Ar or N₂) may also be in communication with the ionic liquid sample to provide for an air and/or oxygen-free environment.

### EXAMPLES

Materials.

1-Hexyl-3-methylimidazolium Chloride (HMIC, 98.0%) was purchased from TCI America, USA. Trihexyl(tetradecyl)phosphonium chloride (THTDPC, 97.0%) was purchased from Strem Chemical, Inc, USA. 1-Hexyl-3-methylimidazolium hexafluorophosphate (HMIHFP, 99%) was purchased from Alfa Aesar, USA. The above ILs were used as purchased.

Preparation of a Half-Cell Using a Standard Ag/AgCl Reference Electrode (+0.225V Vs. Standard Hydrogen Electrode, SHE).

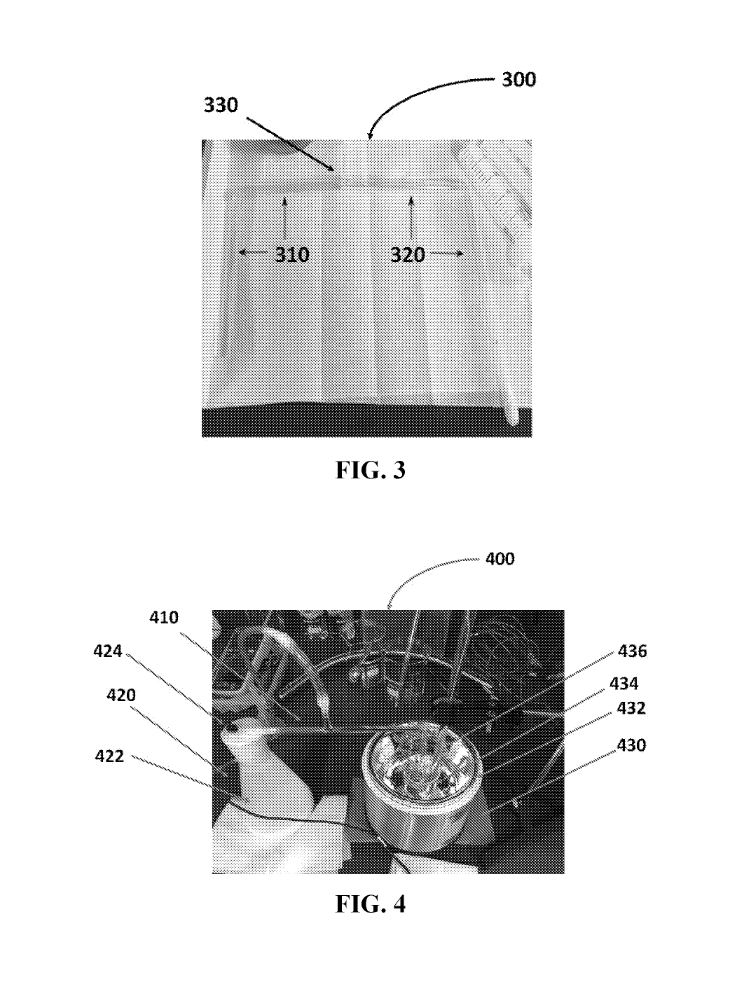

FIG. 3 is a photograph of a salt bridge, according to various aspects of the present disclosure. The salt bridge 300 was formed as follows. First, an Agar-potassium chloride (KCl) paste was prepared by mixing 5 grams (g) of Agar powder and 5 g of KCl powder in 50 milliliters (ml) of deionized water to form a mixture. The mixture was subjected to gentle heating while stirring until the Agar powder was completely dissolved to form an Agar-KCl solution. The Agar-KCl solution was then allowed to cool to form the Agar-KCl paste. Then, a homogenous mixture of ionic liquids was prepared by mixing together 50 g of HMIHFP, 25 g of HMIC, and 25 g of THTDPC. The Agar-KCl paste was then placed in a first half 310 of the salt bridge 300 and the ionic liquid mixture was placed in a second half 320 of the salt bridge 300. The Agar-KCl paste and ionic liquid mixture met at a junction 330 of the salt bridge

Preparation of an Ag/AgCl/HMIC Reference Electrode.

To form an Ag/AgCl/HMIC reference electrode, the following procedure was performed. First, a portion of a silver (Ag) wire was coated with silver chloride (AgCl) by immersing the silver wire in a 0.05M KCl solution and applying 3 volts between the silver wire (anode) and a separate silver wire (cathode) for a period of about 10 minutes to form an Ag/AgCl electrode. The formed Ag/AgCl electrode was subsequently tested to ensure proper function.

The AgCl coated portion of the Ag/AgCl electrode was inserted into a proximal end of a quartz tube. A zirconia rod was inserted into a portion of the distal end of the quartz tube and the zirconia rod and distal end of the quartz tube were fused together to form a cracked junction as described above. HMIC was then added to the quartz tube until the AgCl coated portion of the Ag/AgCl electrode was completely submerged. The proximal end of the quartz tube was then sealed with a portion of the uncoated silver wire extending out of the quartz tube.

Preparation of an Electrochemical Half-Cell.

To establish the electric potential of the Ag/AgCl/HMIC reference electrode fabricated above, an electrochemical half-cell was prepared as shown in FIG. 4. The half-cell 400 includes a salt bridge 410 (as prepared above), a first half-cell compartment 420 and a second half cell compartment 430. The first half cell compartment 420 includes a container 422 filled with a saturated KCl solution and a standard Ag/AgCl reference electrode immersed 424 in the KCl solution as shown. The first half of the salt bridge (which contains an Agar-KCl paste as described above) is also immersed in the KCl solution. The second half-cell compartment 430 includes a cooling unit 432, which can be at least partially filled with a liquid gas (such as, for example, liquid nitrogen) or a mixture of dry ice and acetone, an inner container 434 containing a homogenous mixture of ionic liquids (HMIHFP, HMIC, THTDPC in a 2:1:1 w/w/o ratio), and an Ag/AgCl/HMIC reference electrode 436 (fabricated as discussed above) place at least partially in the homogenous mixture of ionic liquids as shown. The second half of the salt bridge (which contains a homogenous mixture of ionic liquids (HMIHFP, HMIC, THTDPC in a 2:1:1 w/w % ratio) as described above) is also partially immersed in the homogenous mixture of ionic liquids in the inner container 434.

Testing of Ag/AgCl/HMIC Reference Electrode Vs. Standard Ag/AgCl Reference Electrode at Room Temperature.

The Ag/AgCl/HMIC reference electrode was immersed in an electrolyte solution comprising a mixture of ionic liquids (HMIHFP, HMIC, THTDPC in a 2:1:1 w/w % ratio) and the potential difference (open-circuit potential, OCP) between the standard Ag/AgCl reference electrode and the Ag/AgCl/HMIC reference electrode was recorded versus time at room temperature. The experimental setup was illustrated in FIG. 4. The OCP was obtained after one hour of immersion in the mixture of ionic liquids at room temperature. Then, the OCP was again obtained after one day of immersion in the mixture of ionic liquids at room temperature. Then, the OCP was yet again obtained after one day of immersion in the mixture of ionic liquids at room temperature after cooling the mixture of ionic liquids −75° C. and then allowing the mixture to warm to room temperature.

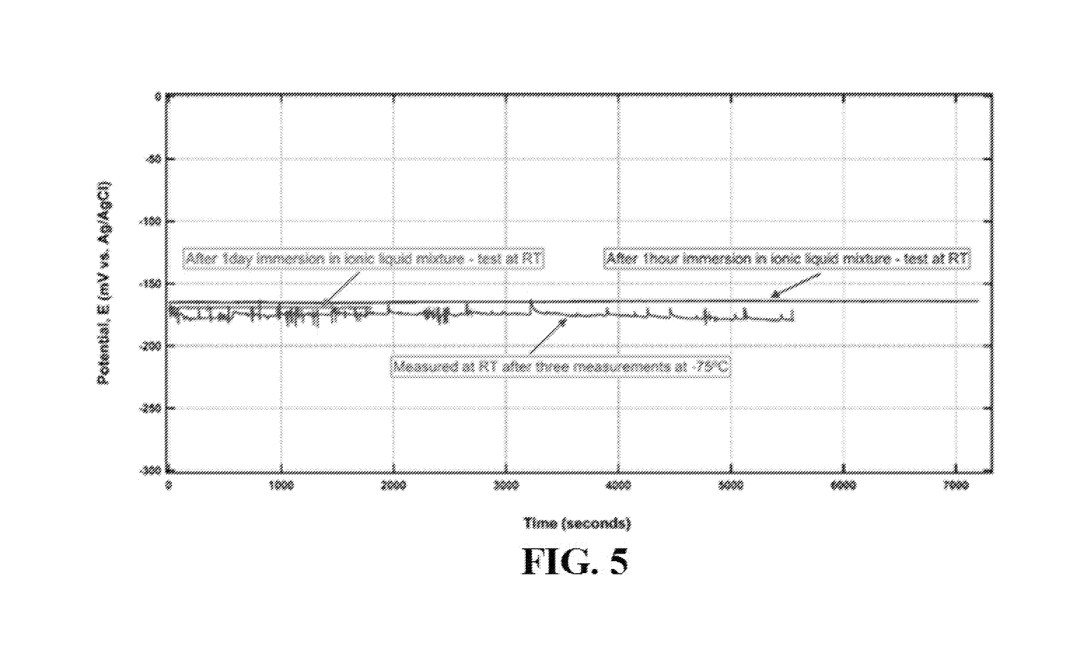

The results of the above experiments are shown in FIG. 5. As can be seen, the standard Ag/AgCl reference electrode was leading the Ag/AgCl/HMIC reference electrode with about 170 mV at room temperature (Ag/AgCl/HMIC vs. standard Ag/AgCl=−170 mV at RT). The almost constant potential difference values indicate that the new Ag/AgCl/HMIC reference electrode worked properly and may be used as a reference electrode for various electrochemical measurements. Without being bound to any particular theory, it is believed that the potential difference observed between the standard reference electrode and the Ag/AgCl/HMIC reference electrode may be attributed to two important factors that affect the chloride ions in the Ag/AgCl/HMIC reference electrode which are 1) chloride ion activity and 2) its mobility in a high viscous medium, the ionic liquid, HMIC.

Testing of Ag/AgCl/HMIC Reference Electrode Vs. Standard Ag/AgCl Reference Electrode at −75° C.

The Ag/AgCl/HMIC reference electrode was immersed in an electrolyte solution comprising a mixture of ionic liquids (HMIHFP, HMIC, THTDPC in a 2:1:1 w/w % ratio) and the potential difference (open-circuit potential, OCP) between the standard Ag/AgCl reference electrode and the Ag/AgCl/HMIC reference electrode was recorded versus time at −75° C. The experimental setup was illustrated in FIG. 4 with a mixture of dry ice and acetone in the cooling unit 432 to cool the inner container 434 containing the homogenous mixture of ionic liquids (HMIHFP, HMIC, THTDPC in a 2:1:1 w/w % ratio) and the Ag/AgCl/HMIC reference electrode to −75° C. In a first measurement, the OCP was obtained after 30 minutes of immersion in the mixture of ionic liquids at −75° C.

In a second measurement, the experimental setup was allowed to warm to room temperature and was maintained at that temperature for one day. The inner container 434 containing the homogenous mixture of ionic liquids (HMIHFP, HMIC, THTDPC in a 2:1:1 w/w % ratio) and the Ag/AgCl/HMIC reference electrode were then gradually cooled to −75° C. The OCP was then obtained after 30 minutes of immersion at −75° C.

In a third measurement, the experimental setup was allowed to warm to room temperature and was maintained at that temperature for one additional day (now two days from the first measurement). The inner container 434 containing the homogenous mixture of ionic liquids (HMIHFP, HMIC, THTDPC in a 2:1:1 w/w %/o ratio) and the Ag/AgCl/HMIC reference electrode were then gradually cooled to −75° C. The OCP was then obtained after 30 minutes of immersion at −75° C.

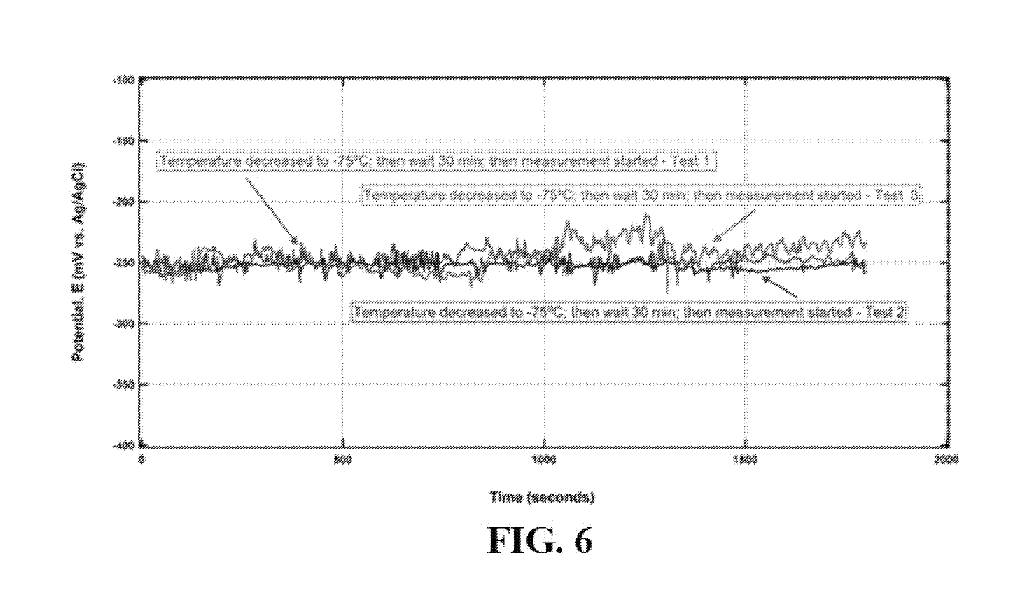

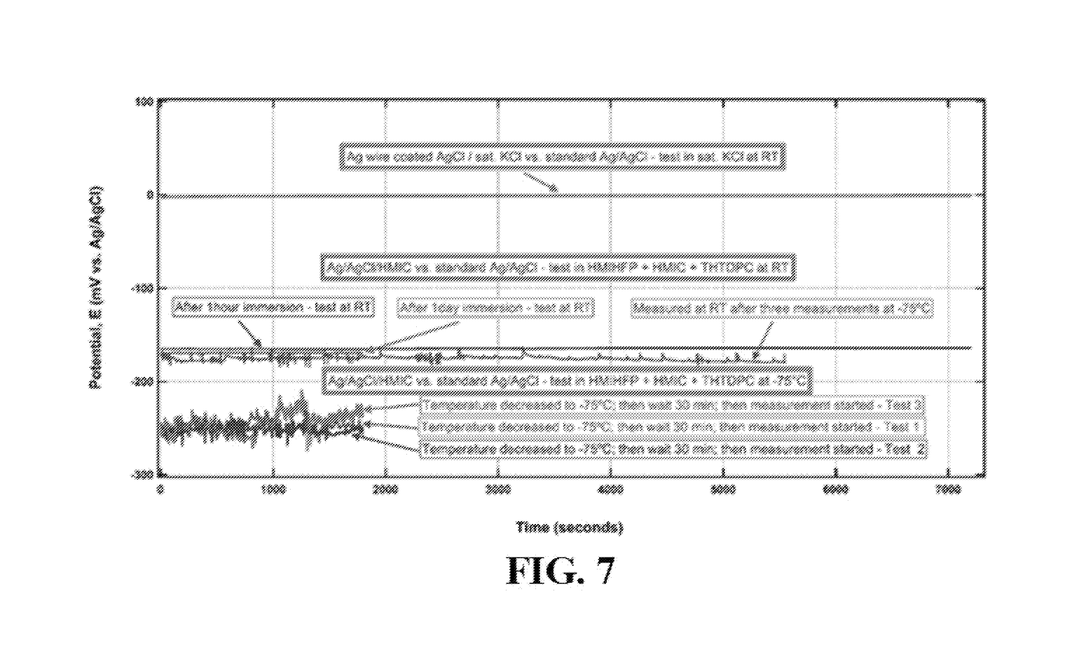

The results of the above experiments are shown in FIG. 6. As can be seen, the results of the three tests at −75° C. (30 min, 1 day, 2 days) showed similar potential differences between the standard Ag/AgCl reference electrode and the Ag/AgCl/HMIC reference electrode. The standard Ag/AgCl reference electrode was leading the Ag/AgCl/HMIC reference electrode with about 250 mV (Ag/AgCl/HMIC vs. standard Ag/AgCl=−250 mV at −75° C.).

The data of FIGS. 5-6, when combined, indicate that on decreasing the temperature from room temperature to −75° C., the potential difference between the two electrodes was only increased by about 80 mV (from −170 mV at RT to −250 mV at −75° C.). Without being bound to any particular theory, it is believed that the increase in potential difference (250 mV) from decreasing the temperature to −75° C. can be attributed to further decrease in chloride ion mobility at lower temperatures as previously explained. The almost constant potential difference value (−250 mV at −75° C.) also indicates that the new Ag/AgCl/HMIC reference electrode worked properly and may be used as a reference electrode for various low temperature electrochemical measurements. FIG. 7 shows the data from both FIGS. 5 and 6.

Statements of the Disclosure include:

Statement 1: A reference electrode, the electrode comprising: a hollow cylindrical body having a proximal end and a distal end; an electrically conductive metal wire partially coated with a metal salt comprising the same metal as the wire, the wire extending through the proximal end of the cylindrical body and terminating near the distal end of the cylindrical body; an ionic liquid contained within a portion of the cylindrical body, the coated portion of the wire being submerged in the ionic liquid; an air-tight seal on the proximal end of the cylindrical body, the uncoated portion of the wire extending through the air-tight seal; and a ceramic rod discontinuously fused with an inner surface of the cylindrical body at a portion of the distal end.

Statement 2: A reference electrode according to Statement 1, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

Statement 3: A reference electrode according to Statement 1 or Statement 2, wherein electrically conductive wire is a Ag/AgCl electrode.

Statement 4: A reference electrode according to any one of Statements 1-3, wherein the ionic liquid comprises an organic cation and an anion.

Statement 5: A reference electrode according to Statement 4, wherein the anion is a halide.

Statement 6: A reference electrode according to Statement 5, wherein the halide is chloride.

Statement 7: A reference electrode according to any one of Statements 1-6, wherein the ionic liquid has a melting point between about −100° C. and about −20° C.

Statement 8: A reference electrode according to any one of Statements 1-7, wherein the ionic liquid is any one of trihexyl(tetradecyl)phosphonium chloride (THTDPC), 1-hexyl-3-methylimidazolium chloride (HMIC), and 1-benzyl-2-ethylimidazolium chloride (BEIC).

Statement 9: A method of electrochemically detecting corrosion in a metal or alloy, the method comprising: electrically coupling a reference electrode with an electrometer, the reference electrode including a hollow cylindrical body having a proximal end and a distal end, an electrically conductive metal wire partially coated with a metal salt comprising the same metal as the wire, the wire extending through the proximal end of the cylindrical body and terminating near the distal end of the cylindrical body, an ionic liquid contained within a portion of the cylindrical body, the coated portion of the wire being submerged in the ionic liquid, an air-tight seal on the proximal end of the cylindrical body, the uncoated portion of the wire extending through the air-tight seal, and a ceramic rod discontinuously fused with an inner surface of the cylindrical body at a portion of the distal end; electrically coupling a sample metal or alloy with the electrometer; submerging the reference electrode and sample metal or alloy in an electrolyte solution at a temperature ranging from about −100° C. to about 200° C.; and measuring the voltage of the reference electrode and comparing it to a predetermined voltage threshold to determine if corrosion of the sample metal or alloy is present.

Statement 10: A method according to Statement 9, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

Statement 11: A method according to Statement 9 or Statement 10, wherein electrically conductive wire is a Ag/AgCl electrode.

Statement 12: A method according to any one of Statements 9-11, wherein the ionic liquid of the reference electrode comprises an organic cation and an anion.

Statement 13: A method according to Statement 12, wherein the anion is a halide.

Statement 14: A method according to Statement 13, wherein the halide is chloride.

Statement 15: A method according to any one of Statements 9-14, wherein the ionic liquid of the reference electrode has a melting point between about −100° C. and about −20° C.

Statement 16: A method according to any one of Statements 9-15, wherein the ionic liquid of the reference is any one of trihexyl(tetradecyl)phosphonium chloride (THTDPC), 1-hexyl-3-methylimidazolium chloride (HMIC), and 1-benzyl-2-ethylimidazolium chloride (BEIC).

Statement 17: A method according to any one of Statements 9-16, wherein the electrolyte solution comprises a mixture of one or more of THTDPC, HMIC and 1-Hexyl-3-methylimidazolium hexafluorophosphate (HMIHFP).

Statement 18: A method according to Statement 17, wherein the mixture comprises HMIHFP, THTDPC, and HMIC in a ratio of about 2:1:1 w/w %.

Statement 19: A method according to any one of Statements 9-18, wherein the reference electrode and sample metal or alloy are submerged in the electrolyte solution at a temperature ranging from about −100° C. to about 0° C.

Statement 20: A method according to any one of Statements 9-18, wherein the reference electrode and sample metal or alloy are submerged in the electrolyte solution at a temperature ranging from about −100° C. to about −20° C.

Statement 21: An electrochemical sensor for measuring the corrosion rate of a metal or alloy, comprising an electrochemical cell in a test loop which includes: a reference electrode electrically coupled with an electrometer, the reference electrode including a hollow cylindrical body having a proximal end and a distal end, an electrically conductive metal wire partially coated with a metal salt comprising the same metal as the wire, the wire extending through the proximal end of the cylindrical body and terminating near the distal end of the cylindrical body, an ionic liquid contained within a portion of the cylindrical body, the coated portion of the wire being submerged in the ionic liquid, an air-tight seal on the proximal end of the cylindrical body, the uncoated portion of the wire extending through the air-tight seal, and a ceramic rod discontinuously fused with an inner surface of the cylindrical body at a portion of the distal end; a working electrode formed of a sample metal or alloy electrically coupled with the electrometer; a counter electrode electrically coupled with the working electrode; and a potentiostat electrically coupled with the electrometer, wherein the corrosion rate of the metal or alloy is measured in the presence of an electrolyte solution at a temperature ranging from about −100° C. to about 200° C.

Statement 22: An electrochemical sensor according to Statement 21, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

Statement 23: An electrochemical sensor according to Statement 21 or Statement 22, wherein electrically conductive wire is a Ag/AgCl electrode.

Statement 24: An electrochemical sensor according to any one of Statements 21-23, wherein the ionic liquid of the reference electrode comprises an organic cation and an anion.

Statement 25: An electrochemical sensor according to Statement 24, wherein the anion is a halide.

Statement 26: An electrochemical sensor according to Statement 25, wherein the halide is chloride.

Statement 27: An electrochemical sensor according to any one of Statements 21-26, wherein the ionic liquid of the reference electrode has a melting point between about −100° C. and about 0° C.

Statement 28: An electrochemical sensor according to any one of Statements 21-27, wherein the ionic liquid of the reference is any one of trihexyl(tetradecyl)phosphonium chloride (THTDPC), 1-hexyl-3-methylimidazolium chloride (HMIC), and 1-benzyl-2-ethylimidazolium chloride (BEIC).

Statement 29: An electrochemical sensor according to any one of Statements 21-28, wherein the electrolyte solution comprises a mixture of one or more of THTDPC, HMIC and 1-Hexyl-3-methylimidazolium hexafluorophosphate (HMIHFP).

Statement 30: An electrochemical sensor according to Statement 29, wherein the mixture comprises HMIHFP, THTDPC, and HMIC in a ratio of about 2:1:1 w/w %.

Statement 31: An electrochemical sensor according to any one of Statements 21-30, wherein the electrolyte solution is flowing.

Statement 32: An electrochemical sensor according to any one of Statements 21-30, wherein the electrolyte solution is stagnant.

Statement 33: An electrochemical sensor according to any one of Statements 21-32, wherein the corrosion rate of the metal or alloy is measured in the presence of the electrolyte solution at a temperature ranging from about −100° C. to about 0° C.

Statement 34: An electrochemical sensor according to any one of Statements 21-32, wherein the corrosion rate of the metal or alloy is measured in the presence of the electrolyte solution at a temperature ranging from about −100° C. to about −20° C.

Although the present invention and its objects, features and advantages have been described in detail, other embodiments are encompassed by the invention. Finally, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A reference electrode, the electrode comprising:
a hollow cylindrical body having a proximal end and a distal end;
an electrically conductive metal wire partially coated with a metal salt comprising the same metal as the wire, the wire extending through the proximal end of the cylindrical body and terminating near the distal end of the cylindrical body;
an ionic liquid contained within a portion of the cylindrical body, the coated portion of the wire being submerged in the ionic liquid;
an air-tight seal on the proximal end of the cylindrical body, the uncoated portion of the wire extending through the air-tight seal; and
a ceramic rod discontinuously fused with an inner surface of the cylindrical body at a portion of the distal end.

2. The reference electrode of claim 1, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

3. The reference electrode of claim 1, wherein electrically conductive wire is a Ag/AgCl electrode.

4. The reference electrode of claim 1, wherein the ionic liquid comprises an organic cation and an anion.

5. The reference electrode of claim 4, wherein the anion is a halide.

6. The reference electrode of claim 5, wherein the halide is chloride.

7. The reference electrode of claim 1, wherein the ionic liquid has a melting point between about −100° C. and about −20° C.

8. The reference electrode of claim 1, wherein the ionic liquid is any one of trihexyl(tetradecyl)phosphonium chloride (THTDPC), 1-hexyl-3-methylimidazolium chloride (HMIC), and 1-benzyl-2-ethylimidazolium chloride (BEIC).

9. A method of electrochemically detecting corrosion in a metal or alloy, the method comprising:
electrically coupling a reference electrode with an electrometer, the reference electrode including:
a hollow cylindrical body having a proximal end and a distal end;
an electrically conductive metal wire partially coated with a metal salt comprising the same metal as the wire, the wire extending through the proximal end of the cylindrical body and terminating near the distal end of the cylindrical body;
an ionic liquid contained within a portion of the cylindrical body, the coated portion of the wire being submerged in the ionic liquid;
an air-tight seal on the proximal end of the cylindrical body, the uncoated portion of the wire extending through the air-tight seal; and
a ceramic rod discontinuously fused with an inner surface of the cylindrical body at a portion of the distal end;
electrically coupling a sample metal or alloy with the electrometer;
submerging the reference electrode and sample metal or alloy in an electrolyte solution at a temperature ranging from about −100° C. to about 200° C.; and
measuring the voltage of the reference electrode and comparing it to a predetermined voltage threshold to determine if corrosion of the sample metal or alloy is present.

10. The method of claim 9, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

11. The method of claim 9, wherein electrically conductive wire is a Ag/AgCl electrode.

12. The method of claim 9, wherein the ionic liquid of the reference electrode comprises an organic cation and an anion.

13. The method of claim 12, wherein the anion is a halide.

14. The method of claim 13, wherein the halide is chloride.

15. The method of claim 9, wherein the ionic liquid of the reference electrode has a melting point between about −100° C. and about −20° C.

16. The method of claim 9, wherein the ionic liquid of the reference is any one of trihexyl(tetradecyl)phosphonium chloride (THTDPC), 1-hexyl-3-methylimidazolium chloride (HMIC), and 1-benzyl-2-ethylimidazolium chloride (BEIC).

17. The method of claim 9, wherein the electrolyte solution comprises a mixture of one or more of THTDPC, HMIC and 1-Hexyl-3-methylimidazolium hexafluorophosphate (HMIHFP).

18. The method of claim 17, wherein the mixture comprises HMIHFP, THTDPC, and HMIC in a ratio of about 2:1:1 w/w %.

19. The method of claim 9, wherein the reference electrode and sample metal or alloy are submerged in the electrolyte solution at a temperature ranging from about −100° C. to about 0° C.

20. The method of claim 9, wherein the reference electrode and sample metal or alloy are submerged in the electrolyte solution at a temperature ranging from about −100° C. to about −20° C.

21. An electrochemical sensor for measuring the corrosion rate of a metal or alloy, comprising an electrochemical cell in a test loop which includes:
a reference electrode electrically coupled with an electrometer, the reference electrode including:
a hollow cylindrical body having a proximal end and a distal end;
an electrically conductive metal wire partially coated with a metal salt comprising the same metal as the wire, the wire extending through the proximal end of the cylindrical body and terminating near the distal end of the cylindrical body;
an ionic liquid contained within a portion of the cylindrical body, the coated portion of the wire being submerged in the ionic liquid;
an air-tight seal on the proximal end of the cylindrical body, the uncoated portion of the wire extending through the air-tight seal; and
a ceramic rod discontinuously fused with an inner surface of the cylindrical body at a portion of the distal end;
a working electrode formed of a sample metal or alloy electrically coupled with the electrometer;
a counter electrode electrically coupled with the working electrode; and
a potentiostat electrically coupled with the electrometer,
wherein the corrosion rate of the metal or alloy is measured in the presence of an electrolyte solution at a temperature ranging from about −100° C. to about 200° C.

22. The sensor of claim 21, wherein the electrically conductive wire is any one of a Ag/AgCl electrode, a Cu/CuCl electrode, a Hg/Hg₂Cl₂, a Ni/NiCl₂ electrode, an Fe/FeCl₂, an Fe/FeCl₃ electrode, a Sn/SnCl₂ electrode, a Pb/PbCl₂ electrode, or a Mn/MnCl₂ electrode.

23. The sensor of claim 21, wherein electrically conductive wire is a Ag/AgCl electrode.

24. The sensor of claim 21, wherein the ionic liquid of the reference electrode comprises an organic cation and an anion.

25. The sensor of claim 24, wherein the anion is a halide.

26. The sensor of claim 25, wherein the halide is chloride.

27. The sensor of claim 21, wherein the ionic liquid of the reference electrode has a melting point between about −100° C. and about 0° C.

28. The sensor of claim 21, wherein the ionic liquid of the reference is any one of trihexyl(tetradecyl)phosphonium chloride (THTDPC), 1-hexyl-3-methylimidazolium chloride (HMIC), and 1-benzyl-2-ethylimidazolium chloride (BEIC).

29. The sensor of claim 21, wherein the electrolyte solution comprises a mixture of one or more of THTDPC, HMIC and 1-Hexyl-3-methylimidazolium hexafluorophosphate (HMIHFP).

30. The sensor of claim 29, wherein the mixture comprises HMIHFP, THTDPC, and HMIC in a ratio of about 2:1:1 w/w %.

31. The sensor of claim 21, wherein the electrolyte solution is flowing.

32. The sensor of claim 21, wherein the electrolyte solution is stagnant.

33. The sensor of claim 21, wherein the corrosion rate of the metal or alloy is measured in the presence of the electrolyte solution at a temperature ranging from about −100° C. to about 0° C.

34. The sensor of claim 21, wherein the corrosion rate of the metal or alloy is measured in the presence of the electrolyte solution at a temperature ranging from about −100° C. to about −20° C.
